(19) United States
(12) Patent Application Publication
(10) Pub. No.: US 2017/0106732 A1
(43) Pub. Date: Apr. 20, 2017

(54) VEHICULAR DOOR SUPPRESSION APPARATUS

(71) Applicant: Robert Todd Tyack, Normandy Park, WA (US)

(72) Inventor: Robert Todd Tyack, Normandy Park, WA (US)

(21) Appl. No.: 15/244,447

(22) Filed: Aug. 23, 2016

Related U.S. Application Data
(60) Provisional application No. 62/242,380, filed on Oct. 16, 2015.

(51) Int. Cl. B60J 11/06; B60R 13/04

(52) U.S. Cl. CPC B60J 11/06; B60R 13/04

(57) ABSTRACT

A suppression assembly designed to suppress blunt impacts is provided. The suppression assembly includes a sheet of magnetic material having a thin profile defined by two opposing attachment surfaces, wherein the sheet of magnetic material is adapted to disperse blunt energy impact so that when place along a vehicular door, the suppression apparatus protects the parked vehicular door against collisions from neighboring automobile's doors.

### CROSS-REFERENCE TO RELATED APPLICATION

This application claims the benefit of priority of U.S. provisional application No. 62/242,380, filed 16 Oct. 2015, the contents of which are herein incorporated by reference.

### BACKGROUND OF THE INVENTION

The present invention relates to vehicular door protectors and, more particularly, a vehicular door suppression apparatus.

Dings, scratches, and other exterior damage to a vehicular door can be maddening to the owner of the vehicle because, even though superficial in nature, such damage lowers the value of the vehicle and diminishes its aesthetically pleasing aspect. Unfortunately, because of the seemingly ever decreasing proximity of adjacent parking spots, such dings and scratches caused by the neighboring vehicle's opening door seem inevitable.

Current, so-called automobile door bumpers are tubular and so bulky and thus hard to store in the vehicle when not in use. Furthermore, the bulkiness takes up the valuable space needed to access the door in the abovementioned close proximity parking spots. Furthermore, such door bumpers are typically made of foam and so tend to be easily saturated with water, becoming even more of a bulky, unsightly nuisance.

As can be seen, there is a need for a vehicular door suppression apparatus that has a thin profile and is water resistant, yet well adapted to suppress the blunt impact of another automotive doors impact, protecting its vehicle's finish.

### SUMMARY OF THE INVENTION

In one aspect of the present invention, a vehicular door suppression apparatus includes an elongated sheet of magnetic material defining a first attachment surface and an opposing second attachment surface, wherein the elongated sheet of magnetic material has a thin profile and is adapted to disperse blunt energy impact.

In another aspect of the present invention, the vehicular door suppression apparatus includes a sheet of magnetic material defining a first attachment surface and an opposing second attachment surface, wherein the sheet of magnetic material is defined by a length of approximately eighteen inches, a width of approximately six inches and a thickness of 0.03 inches; and a cover dimensioned to snugly nest over the first attachment surface, wherein the elongated sheet of magnetic material is adapted to disperse blunt energy impact.

In yet another aspect of the present invention, method of protecting an exterior of a parked vehicle with an apparatus and storing said apparatus includes providing the abovementioned suppression apparatus; placing the first or second attachment surface along the exterior of a parked vehicle; removing the suppression apparatus prior to moving the parked vehicle; and disposing the first or second attachment surface along a ferromagnetic surface along an interior of the parked vehicle.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a perspective view of an exemplary embodiment of the present invention, shown in use; and

FIG. 3 is a section view of an exemplary embodiment of the present invention, shown along line 3-3 in FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a suppression assembly designed to suppress blunt impacts. The suppression assembly includes a sheet of magnetic material having a thin profile defined by two opposing attachment surfaces, wherein the sheet of magnetic material is adapted to disperse blunt energy impact so that when place along a vehicular door, the suppression apparatus protects the parked vehicular door against collisions from neighboring automobile's doors.

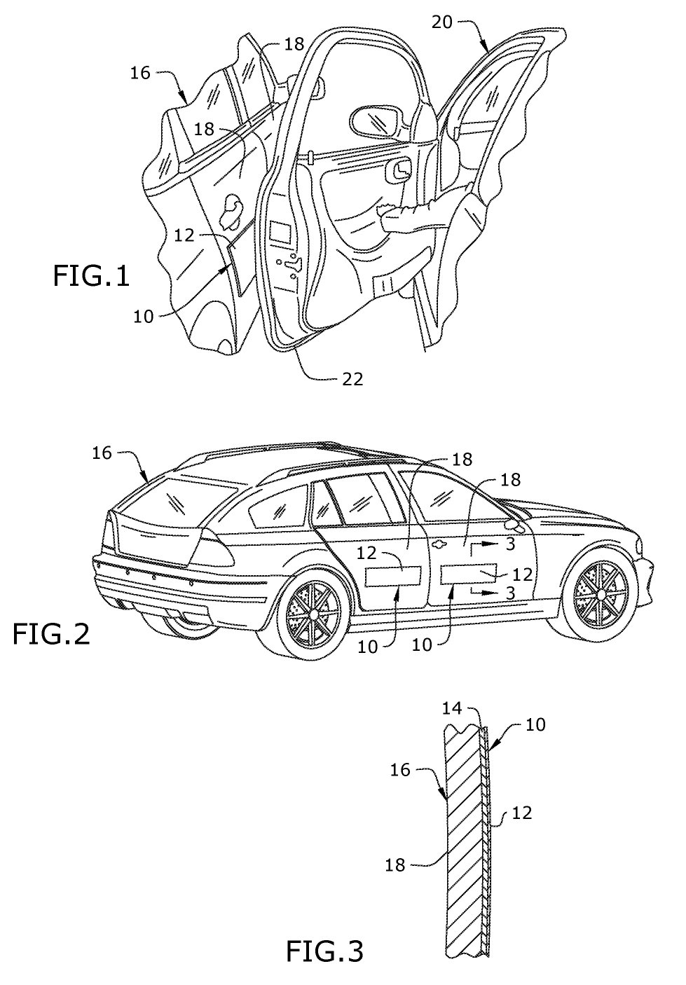

Referring to FIGS. 1 through 3, the present invention may include a suppression assembly 10 designed to suppress blunt impacts. The suppression assembly 10 may be a sheet of magnetic material 14 that will magnetically attach to ferromagnetic surfaces such as metal and the like. The suppression assembly 10 may have a thin profile, in certain embodiments a thickness of 0.03 inches, so as to protrude only 0.03 inches from the surface of the ferromagnetic material to which it attaches. The sheet of magnetic material 14 may be adapted to disperse blunt energy impact.

The suppression assembly 10 may be rectangular, oval, square, triangular or other geometric shape so long as it functions in accordance with the present invention as described herein. The suppression assembly 10 may define an elongated shape having two opposing attachment surfaces, each surface adapted for magnetically attaching to the ferromagnetic surface. In certain embodiments, the suppression assembly 10 may have a length approximately three times its width—for example, eighteen inches by six inches.

The suppression assembly 10 may include a cover 12 adapted to nest over one (first) of the two opposing attachment surfaces, leaving the non-covered (second) attachment surface for attaching to the ferromagnetic surface. In certain embodiments, the cover 12 could be a sleeve for slidably receiving the suppression assembly 10, and both of its two opposing attachment surfaces. The cover 12 may be made of material adapted to disperse blunt energy impact. The cover 12 may be made of materials that can receive automobile paint and graphic printing for protection and decoration purposes. For example, the automobile paint may be a color that matches or complements that of a vehicle 16 it is attached to, thereby blending in and/or camouflaging with the look of the vehicle 16 so as to maintain the vehicle's aesthetically pleasing aspect. The material of the cover 12 may be mylar or the like.

A method of using the present invention may include the following. The suppression assembly 10 disclosed above may be provided. After parking in a tight parking lot, such as those typically found in a shopping mall, a user having only one suppression assembly 10 may place it on the passenger side door 18 of their vehicle 16—i.e., a ferromagnetic surface—because most vehicular door dings and scratches are caused by the driver side door 22 of the neighboring vehicle 20, as illustrated in FIG. 1. Depending on the spatial relationship between the user's vehicle 16 and the neighboring vehicle 20, the user may place the suppression assembly 10 along the passenger side door 18 approximately midpoint there along. In certain embodiments, the suppression assembly 10 may be disposed between the handle and the bottom of the passenger side door 18, as illustrated in FIG. 3. In other embodiments, the user may dispose the suppression assembly 10 along any other parts of the vehicle 16 in need of protection. In some instances, taking advantage of the cover's 12 aesthetically pleasing and/or complementary nature, the user may use the suppression assembly 10 to cover pre-existing damage to the vehicle 16. Of course, the user may place more than one suppression assembly 10 along any and all of the doors of their vehicle 16.

The suppression assembly 10 is easy to removably attach through the magnetic properties of the sheet of magnetic material 14. The sheet of magnetic material 14 is inherently weather proof (in weather conditions from −20 to +120 degrees) and water proof/resistant.

Additionally, the suppression assembly 10 may be used on any ferromagnetic surface in need of protection from blunt impact and other causes of superficial damage. Such ferromagnetic surfaces may be a metal door/drawer, post, stand or the like.

In certain embodiments, when the vehicle owner is set to drive off, the suppression assembly 10 is easily stored when not in use, because of its thin profile and because of its magnetic properties. The magnetic properties enable the suppression assembly to removably attach to the inside of the vehicle along a ferromagnetic surface, such as to the backside of a trunk or pickup box area. In contrast, the prior art usually includes a plurality of components that cannot be as easily stored as the present invention.

In other embodiments, the vehicle owner may keep the at least one suppression assembly 10 disposed along the vehicle 16 or other object, taking advantage of the cover's 12 aesthetically pleasing and/or complementary nature.

It should be understood, of course, that the foregoing relates to exemplary embodiments of the invention and that modifications may be made without departing from the spirit and scope of the invention as set forth in the following claims.

What is claimed is:

1. An apparatus, comprising:
an elongated sheet of magnetic material defining a first attachment surface and an opposing second attachment surface, wherein the elongated sheet of magnetic material has a thin profile and is adapted to disperse blunt energy impact.

2. The apparatus of claim 1, further comprising a cover dimensioned to snugly nest over the first attachment surface.

3. The apparatus of claim 1, wherein the thin profile is defined by a thickness of approximately 0.03 inches.

4. The apparatus of claim 1, wherein the sheet of magnetic material is water resistant.

5. An apparatus, comprising:
a sheet of magnetic material defining a first attachment surface and an opposing second attachment surface, wherein the sheet of magnetic material is defined by a length of approximately eighteen inches, a width of approximately six inches and a thickness of 0.03 inches; and
a cover dimensioned to snugly nest over the first attachment surface,
wherein the elongated sheet of magnetic material is adapted to disperse blunt energy impact, and
wherein the sheet of magnetic material is water resistant.

6. A method of protecting an exterior of a parked vehicle with an apparatus and storing said apparatus, comprising:
providing the suppression apparatus of claim 1;
placing the first or second attachment surface along the exterior of a parked vehicle;
removing the suppression apparatus prior to moving the parked vehicle; and
disposing the first or second attachment surface along a ferromagnetic surface along an interior of the parked vehicle.

7. The method of claim 6, wherein the placing of the first or second attachment surface along the exterior of a parked vehicle is between a handle of the parked vehicles passenger side door and the bottom of said passenger side door.
